(19) United States
(12) Patent Application Publication
(10) Pub. No.: US 2022/0299808 A1
(43) Pub. Date: Sep. 22, 2022

(54) DISPLAY PANEL AND MANUFACTURING METHOD THEREOF

(71) Applicant: TCL China Star Optoelectronics Technology Co., Ltd., Shenzhen (CN)

(72) Inventor: Xing OUYANG, Shenzhen (CN)

(21) Appl. No.: 16/765,895

(22) PCT Filed: Dec. 24, 2019
(86) PCT No.: PCT/CN2019/127722

§ 371 Date: May 21, 2020

(30) Foreign Application Priority Data
Dec. 10, 2019 (CN) 201911261025.6

(51) Int. Cl. G02F 1/1368; G02F 1/1362

(52) U.S. Cl. CPC G02F 1/1368; G02F 1/136286

(57) ABSTRACT

The present disclosure provides a display panel and a manufacturing method thereof. The display panel includes a first substrate, a second substrate, a thin film transistor (TFT) layer, and a cutting protection layer. The first substrate includes a cutting region, the second substrate is disposed opposite to the first substrate, and the TFT layer is disposed on the second substrate. The TFT layer includes a cutting protection region corresponding to the cutting region, and the cutting protection layer is disposed on the TFT layer and located in the cutting protection region.

### FIELD OF INVENTION

The present disclosure relates to the display panel field, and more particularly, to a display panel and a manufacturing method thereof.

### BACKGROUND OF INVENTION

During manufacturing of display panels into cells, a large plate glass substrate needs to be cut into small plate display devices. Specifically, cutting needs to be performed in a cutting region of color film glass substrates, so that a corresponding part of thin film transistor (TFT) side substrates is exposed, which facilitates subsequent bonding.

### SUMMARY OF INVENTION

At present, during a cutting and separating process in a cutting region of color film glass substrates, cutting residue (glass shards) may easily scratch an insulating layer and a metal wiring layer below the cutting region in a peeling process. And then a scratched wound is too small to difficultly detect, it directly remains in the subsequent process. Current metal wiring layers in the scratched region are arranged in a bow-shaped, and a line width is narrow and relatively dense. In a process of scratching, it is easy to cause an interruption of circuit, which causes defects of vertical dark stripes in a display panel display process. And such quality defects are difficult to remedy.

Embodiments of the present disclosure provide a display panel and a manufacturing method thereof to solve the problem that cutting residue (glass shards) may easily scratch the insulating layer and the metal wiring layer below the cutting region in the peeling process.

One aspect of an embodiment of the present disclosure provides a display panel. The display panel comprises a first substrate comprising a cutting region, a second substrate disposed opposite to the first substrate, a thin film transistor layer disposed on the second substrate and comprising a cutting protection region corresponding to the cutting region, and a cutting protection layer disposed on the thin film transistor layer and located in the cutting protection region.

In the display panel of the embodiment of the present disclosure, the display panel comprises a color resist layer disposed between the first substrate and the second substrate, and a material of the cutting protection layer is a color resist material.

In the display panel of the embodiment of the present disclosure, the cutting protection layer and the color resist layer are an integrally-formed structure.

In the display panel of the embodiment of the present disclosure, the display panel comprises a columnar spacer between the first substrate and the second substrate, and a material of the columnar spacer is same as a material of the cutting protection layer.

In the display panel of the embodiment of the present disclosure, the cutting protection layer and the columnar spacer are an integrally-formed structure.

In the display panel of the embodiment of the present disclosure, an orthographic projection of the cutting protection layer on the first substrate covers the cutting region of the first substrate.

In the display panel of the embodiment of the present disclosure, the thin film transistor layer comprises a first insulating layer disposed on the second substrate, a metal wiring layer disposed on the first insulating layer, and a second insulating layer disposed on the metal wiring layer, and the cutting protection layer is disposed on the second insulating layer.

In the display panel of the embodiment of the present disclosure, the cutting protection region of the metal wiring layer comprises a plurality of metal sub-wirings which are mutually parallel in arrangement.

In the display panel of the embodiment of the present disclosure, a line width of the metal sub-wirings ranges from 3.5 μm to 6 μm.

In the display panel of the embodiment of the present disclosure, a line width of the metal sub-wirings is greater than 10.5 μm.

In the display panel of the embodiments of the present disclosure, a horizontal width of the cutting protection region is greater than a horizontal width of the cutting region.

According to the above purpose of the present disclosure, the present disclosure further provides a manufacturing method of the display panel. The manufacturing method comprises steps as follows: providing a first substrate and a second substrate, which are disposed opposite of each other, wherein the first substrate comprises a cutting region; forming a thin film transistor layer on the second substrate, wherein the thin film transistor layer comprises a cutting protection region corresponding to the cutting region; and forming a cutting protection layer located in the cutting protection region on the thin film transistor layer.

In the manufacturing method of the display panel of the embodiment of the present disclosure, the manufacturing method comprises forming a color resist layer on the thin film transistor layer after forming the thin film transistor layer on the second substrate.

In the manufacturing method of the display panel of the embodiment of the present disclosure, the step of the cutting protection layer located in the cutting protection region on the thin film transistor layer comprises a step of integrally forming the cutting protection layer and the color resist layer by a same process, and a material of the cutting protection layer is a color resist material.

In the manufacturing method of the display panel of the embodiment of the present disclosure, the manufacturing method comprises forming a columnar spacer on the thin film transistor layer after forming the thin film transistor layer on the second substrate.

In the manufacturing method of the display panel of the embodiment of the present disclosure, the step of the cutting protection layer located in the cutting protection region on the thin film transistor layer comprises a step of integrally forming the cutting protection layer and the columnar spacer by a same process, and a material of the columnar spacer is same as a material of the cutting protection layer.

A display panel provided by the present disclosure buffers and blocks glass shards generated by glass cutting and peeling in the cutting region by disposing the cutting protection layer above the metal wiring layer, which reduces a direct impact or contact of glass shards on the metal wiring layer, and reduces a chance of the metal wiring layer being scratched and damaged. Meanwhile, the overall manufacturing method of a structure is simple and suitable for mass production.

### DESCRIPTION OF DRAWINGS

FIG. 1 is a schematic structural diagram of a display panel of one embodiment of the present disclosure.

FIG. 2 is a schematic structural diagram of a display panel of another embodiment of the present disclosure.

FIG. 3 is a schematic top structural diagram of a metal wiring layer located in a cutting protection region in a current display panel.

FIG. 4 is a schematic top structural diagram of a metal wiring layer located in a cutting protection region in a display panel provided by one embodiment of the present disclosure.

FIG. 5 is a schematic top structural diagram of a metal wiring layer located in a cutting protection region in a display panel provided by another embodiment of the present disclosure.

### DETAILED DESCRIPTION OF PREFERRED EMBODIMENTS

The technical solutions in the embodiments of the present disclosure will be clearly and completely described below in conjunction with accompanying drawings in the embodiments of the present disclosure. Obviously, the embodiments described are merely a part of the present disclosure, rather than all the embodiments. All other embodiments obtained by the person having ordinary skill in the art based on embodiments of the disclosure, without making creative efforts, are within the scope of the present disclosure.

In descriptions of the present disclosure, it should be noted that, orientations or position relationships indicated by the terms, such as “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, etc. are based on the orientations or position relationships shown in the drawings. These are only convenience for describing the present disclosure and simplifying the descriptions, and does not indicate or imply that the device or element must have a specific orientation, a structure and an operation in the specific orientation, so it cannot be understood as a limitation on the present disclosure. In addition, the terms “first” and “second” are used for describing purposes only, and cannot be understood as indicating or implying relative importance or implicitly indicating the number of technical features indicated. Thus, the features defined as “first” and “second” may explicitly or implicitly include one or more of the features. In the descriptions of the present disclosure, the meaning of “plurality” is two or more, unless it is specifically defined otherwise.

In the present disclosure, the terms “mounting”, “connected”, “fixed” and the like should be broadly understood unless expressly stated or limited otherwise. For example, it may be fixed connected, removably connected, or integrated; it may be mechanically connected, or an electrically connected; it may be directly connected, or indirectly connected through an intermediary; it may be a connection between two elements or an interaction between two elements. For those skilled in the art, the specific meanings of the above terms in the present disclosure may be understood based on specific situations.

In the present disclosure, unless explicitly stated and defined otherwise, the first feature may be “above” or “below” the second feature and may include direct contact between the first and second features. It may also include that the first and second features are not in direct contact but are contacted by another feature between them. Moreover, the first feature is “above” the second feature, including the first feature directly above and obliquely above the second feature, or merely indicates that the first feature is higher in level than the second feature. The first feature is “below” the second feature, including the first feature is directly below and obliquely below the second feature, or only indicates that the first feature is less horizontal than the second feature.

The following disclosure provides many different embodiments or examples for achieving different structures of the present disclosure. To simplify the present disclosure, components and settings of specific examples are described below. They are only examples and are not intended to limit the present disclosure. In addition, the present disclosure may repeat reference numbers and/or reference letters in different examples, this repetition is for the purpose of simplicity and clarity, and does not itself indicate the relationship between various embodiments and/or settings discussed. In addition, the present disclosure provides examples of various specific processes and materials, but those of ordinary skill in the art may be aware of the present disclosure of other processes and/or the use of other materials.

The present disclosure is described in detail with reference to the accompanying drawings hereinafter.

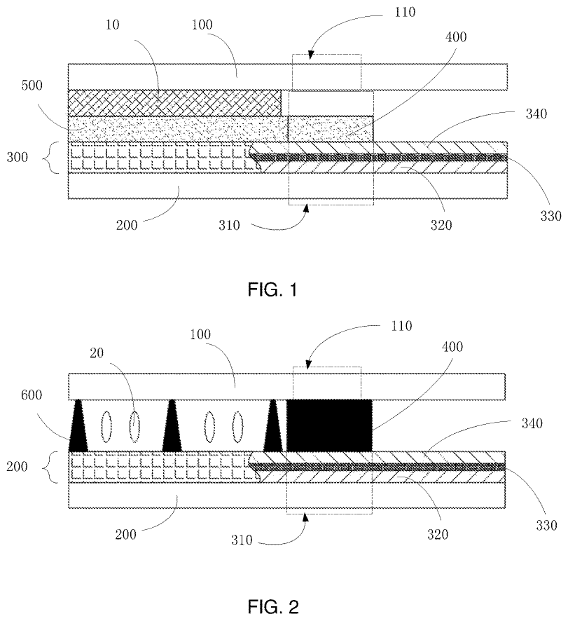

As shown in FIG. 1 and FIG. 2, an embodiment of the present disclosure provides a display panel. The display panel comprises a first substrate 100 comprising a cutting region 110, a second substrate 200 disposed opposite to the first substrate 100, a thin film transistor layer 300 disposed on the second substrate 200 and comprising a cutting protection region 310 corresponding to the cutting region 110, and a cutting protection layer 400 disposed on the thin film transistor layer 300 and located in the cutting protection region 310.

It should be understood that the cutting region 110 and the cutting protection region 310 are both located in a non-display region of the display panel. In a current process, the first substrate 100 may be understood as a color film side glass substrate (a glass substrate near a side of a color film substrate in an opposite display panel structure), and the second substrate 200 may be understood as a thin film transistor side glass substrate (a glass substrate near a side of the thin film transistor layer 300 in the opposite display panel structure).

In the present embodiment, a horizontal width of the cutting protection region 310 is greater than a horizontal width of the cutting region 110. It should be understood that when the first substrate 100 is specifically cut in the cutting region 110, degrees of influence on the TFT layer 300 become smaller with a distance of the cutting region 110, but an overall affected region (namely, the cutting protection region 310) is obviously greater than the cutting region 110. Thus, as shown in FIG. 1 and FIG. 2, the horizontal width of the specific cutting protection region 310 is greater than the horizontal width of the cutting region 110 in the present embodiment. The cutting protection layer 400 covers the overall cutting protection region 310 in a horizontal direction, so that an orthographic projection of the cutting protection layer 400 on the first substrate 100 covers the cutting region 110 on the first substrate 100.

In the present embodiment, as shown in FIG. 1, take a structure of a color filter on array (COA) type display panel as an example, the display panel comprises a color resist layer 500 between the first substrate 100 and the second substrate 200. A material of the cutting protection layer 400 is a color resist material, and the cutting protection layer 400 and the color resist layer 500 are an integrally-formed structure.

It should be understood that the cutting protection layer 400 and the color resist layer 500 are an integrally-formed structure, which is convenient for extending and coating the color resist material in the cutting protection region 310 when the color resist layer 500 is manufactured in a COA process. Compared to the COA process, it only needs to slightly change an original mask pattern design, and other additional materials or processes are not needed. The material of the cutting protection layer 400 may be one of the color resist materials in the color resist layer 500. In addition, on the specific panel structure, there are other functional layers 10 (such as a liquid crystal layer, etc.) between the color resist layer 500 and the first substrate 100.

In the present embodiment, as shown in FIG. 2, the display panel comprises a columnar spacer 600 between the first substrate 100 and the second substrate 200, a material of the columnar spacer 600 is same as the material of the cutting protection layer 400, and the cutting protection layer 400 and the columnar spacer 600 are an integrally-formed structure.

It should be understood that the cutting protection layer 400 and the columnar spacer 600 are an integrally-formed structure, which is convenient for extending and coating a columnar spacer material in the cutting protection region 310 when the columnar spacer 600 is manufactured. Compared to the current process, it also just needs to correspondingly change the mask pattern on the original mask design, and other additional materials or processes are not needed. In addition, it should be understood that the specific panel structure comprises a liquid crystal layer 20 filled between each of the columnar spacers 600, and other structures which are conventional technical structures of current display panels, and they are not repeated herein.

Furthermore, as shown in FIG. 1 and FIG. 2, in a structure in which the cutting protection layer 400 and the color resist layer 500 are integrated, since the color resist layer 500 is manufactured by a same process, a thickness of the cutting protection layer 400 is same as a thickness of the color resist layer 500. In a structure in which the cutting protection layer 400 and the columnar spacer 600 are integrated, since the columnar spacer 600 is manufactured by a same process, a thickness of the cutting protection layer 400 is same as a thickness of the columnar spacer 600, and the thickness is much greater than a thickness of the integrally structure of the cutting protection layer 400 and the color resist layer 500. In the present disclosure, the cutting protection layer 400 may also be other materials with certain functionality (such as toughness and good strength), which have better protection performance for the TFT layer 300 than the color resist material or the material of columnar spacer 600.

In the present embodiment, as shown in FIG. 1 and FIG. 2, a portion of a TFT array structure located in a display region is not specifically illustrated. Correspondingly, in the present disclosure, the TFT layer 300 comprises a first insulating layer 320 extending from the portion of TFT array structure and disposed on the second substrate 200, a metal wiring layer 330 disposed on the first insulating layer 320, and a second insulating layer 340 disposed on the metal wiring layer 330, and the cutting protection layer 400 is disposed on the second insulating layer 340.

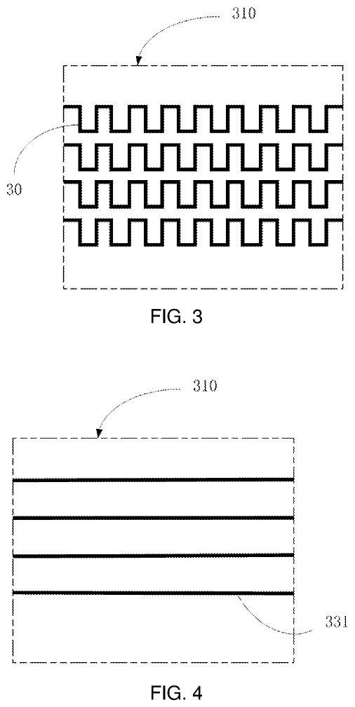

In the present embodiment, the cutting protection region 310 of the metal wiring layer 330 comprises a plurality of metal sub-wirings 331 which are mutually parallel in arrangement. Compared to the one shown in FIG. 3, it is a current portion of the metal wiring layer located in the cutting protection region 310, which comprises a plurality of parallel metal wirings 30 arranged in a square wave. Wherein, a width of the metal line in the square-wave metal wiring 30 is d1, and an overall width of the square wave in the square-wave metal wirings 30 is d2.

It should be noted that, at present, during the cutting and separating process in the cutting region of the color film glass substrates, cutting residue (glass shards) may easily scratch the insulating layer and the metal wiring layer 330 below the cutting region 110 in the peeling process. Although the cutting protection layer 400 is not provided in the present disclosure, the impact of cutting on the TFT layer 300 may only be reduced. When the cutting glass shards have a certain kinetic energy under special circumstances, there will also be fewer glass shards that cause scratches on the cutting protection layer 400, the insulating layer, and even the metal wiring layer 330. As the current metal wiring layer 330 in the cutting protection region 310 is in the square wave arrangement with a narrower line width and is relatively dense, in order to prevent it from easily causing interruption of circuit when scratched, which causes defects of vertical dark stripes in a display panel display process, in the present disclosure, based on a design of the cutting protection layer 400 structure, the cutting protection region 310 of the metal wiring layer 330 is designed to comprise a plurality of metal sub-wirings 331 which are mutually parallel in arrangement.

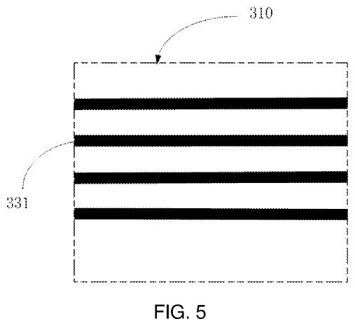

Furthermore, the plurality of metal sub-wirings 331 are mutually parallel in arrangement as shown in FIG. 4, a line width of the metal sub-wirings 331 is d3, and d3=d1, so that the metal sub-wirings 331 have smaller line width and a distance between two adjacent metal sub-wirings 331 is increased. A whole area ratio of the metal sub-wirings 331 is reduced, thereby reducing the chance of glass shards scratching the metal sub-wirings 331 and achieving an effect of preventing scratches. Specifically, the line width of the metal sub-wirings 331 ranges from 3.5 μm to 6 μm.

Furthermore, as shown in FIG. 5, in the present embodiment, the line width of the metal sub-wirings 331 is d3, and d2>d3≥3d1, so that the metal sub-wirings 331 have wider line width, thereby reducing the chance of the metal sub-wirings 331 causing interruption of circuit after being scratched by glass shards. Moreover, it minimizes an impact of subsequent display functions of the display panel after being scratched by glass shards. Specifically, the line width of the metal sub-wirings 331 is greater than 10.5 μm. It should be noted that in the present disclosure, the line width of the metal sub-wirings 331 is not as wide as possible, and a prevention of electrostatic damage between the metal sub-wirings 331 after increasing the line width of the metal sub-wirings 331 is also considered. Specifically, it can be set according to different display panel product specifications. For example, in the current display panel structures, each of the metal sub-wirings 331 is respectively connected to a wide line in a bonding region of the display panel, and a specific width of the metal sub-wirings 331 may also appropriately refer to a width of the wide line in the bonding region. In addition, in the display panel design, there is also a minimum distance for the design of the metal sub-wirings 331, which may also be used as a reference.

In summary, a way of disposing the cutting protection layer above the metal wiring layer buffers and blocks glass shards generated by glass cutting and peeling in the cutting region, which reduces the direct impact or contact of glass shards on the metal wiring layer, and reduces the chance of the metal wiring layer being scratched and damaged. Meanwhile, a structure that combines the cutting protection region of the metal wiring layer with the plurality of metal sub-wirings which are mutually parallel in arrangement reduces the chance of the metal sub-wirings causing interruption of circuit after being scratched by glass shards. Moreover, it minimizes the impact of subsequent display functions of the display panel after being scratched by glass shards.

The present disclosure further provides a manufacturing method of the display panel, comprising steps as follows:

Step S1: providing a first substrate 100 and a second substrate 200, which are disposed opposite of each other, wherein the first substrate 100 comprises a cutting region 110.

Step S2: forming a thin film transistor (TFT) layer 300 on the second substrate 200, wherein the TFT layer 300 comprises a cutting protection region 310 corresponding to the cutting region 110.

Step S3: forming a cutting protection layer 400 located in the cutting protection region 310 on the TFT layer 300.

Specifically, Step S3, is forming the cutting protection layer 400 located in the cutting protection region 310 on the TFT layer 300. As mentioned above, a material of the cutting protection layer 400 may be a same color resist material as a color resist layer 500, or may be a same material of the columnar spacer 600 as the columnar spacer 600. In a manufacturing process, the cutting protection layer 400 may be formed in a same process as the color resist layer 500 or the columnar spacer 600 in an original display panel manufacturing process, and do not require additional process steps. In addition, the cutting protection layer 400 may be made of other materials. In this case, additional process steps are required, and the cutting protection layer 400 is formed in the cutting protection region 310.

In summary, the manufacturing method of the display panel of the present disclosure forms the cutting protection layer in the cutting protection region, which achieves the protection of the TFT layer when the first substrate is being cut. Meanwhile, the overall manufacturing process is simple and suitable for mass production.

In summary, the present disclosure buffers and blocks glass shards generated by glass cutting and peeling in the cutting region by disposing the cutting protection layer above the metal wiring layer, which reduces the direct impact or contact of glass shards on the metal wiring layer, and reduces the chance of the metal wiring layer being scratched and damaged. Meanwhile, the overall manufacturing method of the structure is simple and suitable for mass production.

In the above embodiment, a description of each embodiment has its own emphasis. For a part that is not described in detail in an embodiment, refer to the description of other embodiments.

The embodiments of the present disclosure have been described in detail above. The present disclosure uses specific examples to describe principles and embodiments of the present disclosure. The descriptions of the above embodiments are only used to help understand technical solutions of the present disclosure and core ideas thereof. Moreover, those of ordinary skill in the art should understand that the technical solutions described in the aforesaid embodiments can still be modified, or have some technical features equivalently replaced. However, these modifications or replacements do not depart from a scope of the technical solutions of the embodiments of the present disclosure.

What is claimed is:

1. A display panel, comprising:
a first substrate comprising a cutting region;
a second substrate disposed opposite to the first substrate;
a thin film transistor layer disposed on the second substrate and comprising a cutting protection region corresponding to the cutting region; and
a cutting protection layer disposed on the thin film transistor layer and located in the cutting protection region.

2. The display panel as claimed in claim 1, wherein the display panel comprises a color resist layer disposed between the first substrate and the second substrate, and a material of the cutting protection layer is a color resist material.

3. The display panel as claimed in claim 2, wherein the cutting protection layer and the color resist layer are an integrally-formed structure.

4. The display panel as claimed in claim 1, wherein the display panel comprises a columnar spacer between the first substrate and the second substrate, and a material of the columnar spacer is same as a material of the cutting protection layer.

5. The display panel as claimed in claim 4, wherein the cutting protection layer and the columnar spacer are an integrally-formed structure.

6. The display panel as claimed in claim 1, wherein an orthographic projection of the cutting protection layer on the first substrate covers the cutting region of the first substrate.

7. The display panel as claimed in claim 6, wherein the thin film transistor layer comprises a first insulating layer disposed on the second substrate, a metal wiring layer disposed on the first insulating layer, and a second insulating layer disposed on the metal wiring layer, and the cutting protection layer is disposed on the second insulating layer.

8. The display panel as claimed in claim 7, wherein the cutting protection region of the metal wiring layer comprises a plurality of metal sub-wirings which are mutually parallel in arrangement.

9. The display panel as claimed in claim 8, wherein a line width of the metal sub-wirings ranges from 3.5 μm to 6 μm.

10. The display panel as claimed in claim 8, wherein a line width of the metal sub-wirings is greater than 10.5 μm.

11. The display panel as claimed in claim 1, wherein a horizontal width of the cutting protection region is greater than a horizontal width of the cutting region.

12. A manufacturing method of a display panel, comprising steps as follows:
providing a first substrate and a second substrate, which are disposed opposite of each other, wherein the first substrate comprises a cutting region;
forming a thin film transistor layer on the second substrate, wherein the thin film transistor layer comprises a cutting protection region corresponding to the cutting region; and
forming a cutting protection layer located in the cutting protection region on the thin film transistor layer.

13. The manufacturing method of the display panel as claimed in claim 12, comprising forming a color resist layer on the thin film transistor layer after forming the thin film transistor layer on the second substrate.

14. The manufacturing method of the display panel as claimed in claim 13, wherein the step of forming the cutting protection layer located in the cutting protection region on the thin film transistor layer comprises a step of integrally forming the cutting protection layer and the color resist layer by a same process, wherein a material of the cutting protection layer is a color resist material.

15. The manufacturing method of the display panel as claimed in claim 12, comprising forming a columnar spacer on the thin film transistor layer after forming the thin film transistor layer on the second substrate.

16. The manufacturing method of the display panel as claimed in claim 15, wherein the step of forming the cutting protection layer located in the cutting protection region on the thin film transistor layer comprises a step of integrally forming the cutting protection layer and the columnar spacer by a same process, wherein a material of the columnar spacer is same as a material of the cutting protection layer.
